(19) United States
(12) Patent Application Publication
(10) Pub. No.: US 2018/0268369 A1
(43) Pub. Date: Sep. 20, 2018

(54) GLOBAL ADDRESS SYSTEM AND METHOD

(71) Applicant: Sarwar Pedawi, Dubai (AE)

(72) Inventor: Sarwar PEDAWI, Dubai (AE)

(21) Appl. No.: 15/461,100

(22) Filed: Mar. 16, 2017

(51) Int. Cl. G06Q 10/08; G06K 19/06; G01C 21/00; G01S 19/13; G01S 19/46

(52) U.S. Cl. CPC G06Q 10/08355; G06K 19/06028; G01S 19/46; G01S 19/13; G01C 21/005

(57) ABSTRACT

This disclosure relates to a system, method, and computer-readable device configured to receive demographic and geographical information and create a unique global address therefrom. For example, the system comprises at least one processor configured to receive account information describing the remote user and global location data describing a remote location, validate the received information and data, determine navigational data, create a location code, and send the location code to a remote device.

### BACKGROUND OF THE INVENTION

This disclosure relates to a system, method, and computer-readable device for creating a global address code, in particular, a global address code to provide a uniform address code for any location in the world and to aid in the delivery of services or goods.

Correct addressing is of great importance for enabling the localization of persons, objects, companies and other entities. Correct addressing can furthermore contribute to environmental planning, give a strong impulse to regional, continental and global welfare and facilitate economic, political and social interaction. However, there are regions in the world where addressing is underdeveloped or even absent. Postal codes, street names and/or house numbers are not provided, not logically structured, and/or not registered in a central database. Hence, persons, objects, companies and other entities cannot be easily found and mail and packages are not reliably delivered. As a result, mail carriers refuse to deliver to unmarked locations that do not currently have an assigned street address. This causes unnecessary confusion and can delay the economic development of a region. Delivery systems are known which allow for setting a drop-box as an alternative to an unclear address. The number and availability of drop-boxes are, however, simply too limited.

### SUMMARY OF THE INVENTION

According to a first aspect, the present disclosure provides a system, method, and tangible computer-readable device for creating a global address. Specifically, the present disclosure provides a system, method, and computer-readable device comprising a memory, at least one processor or processing module, and a communications link capable of facilitating data transmissions between a remote device associated with a specific remote user and the processor or processing module. The system's processor or processing module are configured to receive account information and location data, describing a specific user and a specific global location, respectively. Upon validating the received information and data, the processor determines navigational data for the receiving location. The processor is further configured to create a location code based at least in part on the received account information, the received location data, and the determined navigational data.

In an embodiment, the present disclosure further provides a method for requesting a global address. The method includes sending account information and global location data to a remote computer. In an embodiment, the global location data may include at least one of longitude, latitude, and altitude of a specific global location. The method further includes receiving a location code from the remote computer. In an embodiment, the location code is based at least in part on a combination of the account information, the specific global location, and the navigational data. The location code may be printed, thereby producing a physical label.

In an embodiment, the account information may include a username and/or password. In yet another embodiment, the system, method, and computer-readable device may provide an interactive map to a remote user to obtain location data based on the user's selection.

### BRIEF DESCRIPTION OF THE DRAWINGS

The invention will be elucidated on the basis of a number of exemplary embodiments shown in the attached schematic drawings, in which:

FIG. 1 is an example computer system useful for implementing various embodiments.

FIG. 2 is a block diagram of processing nodes and modules, according to various embodiments.

FIG. 3 is a flowchart illustrating a process for creating a global address, according to an example embodiment.

FIG. 4 is a schematic view of the delivery system with an ordering section, a localization section and a delivery section according to an embodiment of the invention;

FIG. 5 is a schematic view of the delivery section of the delivery system according to an embodiment; and

FIG. 6 is a schematic comparison between the coverage of a conventional addressing system and a delivery system according to an embodiment.

### DETAILED DESCRIPTION OF THE INVENTION

As required, a detailed illustrative embodiment of the present invention is disclosed herein. However, techniques, systems and operating structures in accordance with the present disclosure may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention. The following presents a detailed description of a preferred embodiment as well as alternate embodiments such as a simpler embodiment or more complex embodiments for alternate devices of the present invention.

In countries around the world, many geographical addressing systems have been created in order to identify or describe a geographic location of a specific residence, business, street address, etc. Each country or principality has adopted its own version of such geographic addressing systems. For example, in the United States one generally identifies/describes a geographic location using a street number, street name, city, state, and a zipcode that includes up to nine numerical digits. Other countries also use postal codes similar to the United States zipcode. However, in countries like Canada, the postal code may indicate on which side of a residential street a person lives. In the United Kingdom, there are at least six valid postcode formats that mix and match alphanumeric characters to create an outward code and an inward code. In many countries and principalities around the world, there are geographic locations that do not have any type of addressing system. Rural areas such as areas outside Erbil city in Kurdistan, Iraq, have no existing address systems. Thus, in some areas of the world, very complex addressing systems are in place, while other portions of the world have no such system at all.

In view of the foregoing, there exists a need for an improved system, method, and apparatus for creating a globally recognized addressing system.

This disclosure provides a method and system for creating a unique global address code for any location in the world. The disclosure further provides a localization system for determining or confirming data describing a location, in particular a delivery location for delivery of services or goods, wherein the location can be provided with a uniform address or location code.

For illustrative purposes, embodiments, as provided herein, are described with respect to creating a unique global address for locations worldwide. A skilled artisan would recognize that the techniques disclosed herein can be applied to other sorts of personal and/or entity information.

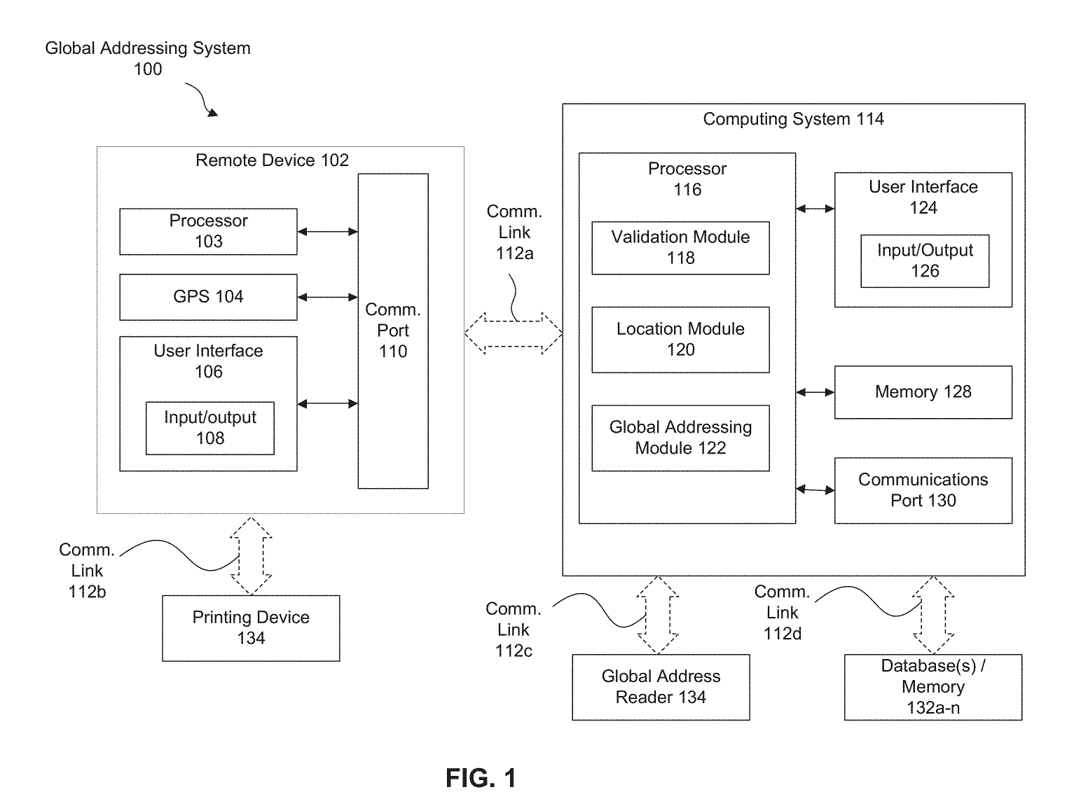

FIG. 1 illustrates a functional block diagram of an exemplary global addressing system 100, useful for implementing various embodiments of the present disclosure. As will be described in greater detail below, a user may interact with global addressing system 100 to create a global address code for a specific global location. As depicted, remote device 102 is in electronic communication with at least one computing system 114 over communications link 112a and at least one printing device 134 over communications link 112b. In an embodiment, remote device 102 includes one or more features to provide additional functionality. For example, the remote device 102 may include, for example, processor 103, global positioning system (“GPS”) receiver 104, user interface 106, and communications port 110. In an embodiment, user interface 106 may further include user input/output device(s) 108.

The computing system 114 likewise includes one or more features to provide additional functionality. For example, computing system 114 may include at least one processor 116, user interface 124, and communications port 130. In an embodiment, processor(s) 116 may additionally include validation module 118, location module 120, and global addressing module 128. In an embodiment, user interface 124 may further include user input/output device(s) 122. In an embodiment, computing system 114 is in electronic communication with global address reader 134 over communications link 112c and/or at least one database/memory system, i.e., database memory 132a-n over communications link 112d.

For purposes of this discussion, the term “module” shall be understood to include at least one of software, firmware, and hardware (such as one or more circuit, microchip, processor, or device, or any combination thereof), and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner. As such, one or more modules may be used alone (or in combination) to provide an improved system, method, or apparatus for creating a unique global address code for a specific global location.

Remote device 102 is a remote computing device capable of interacting with a remote user. In an embodiment, the remote device may be implemented using a personal computer, a laptop computer, a tablet, a smartphone, or other communications device capable of communicating with computing system 114 over a communications link. As will be discussed in greater detail below, a remote user may interact with remote device 102 to send demographic and/or geographic data, describing a specific person or place, to computing system 114. Further, as will be discussed in greater detail below, computing system 114 uses this information to generate a global address describing the specific person or global location.

In an embodiment, remote device 102 includes GPS receiver 104. GPS receiver 104 may be implemented using either global navigation satellite system (GNSS) type receivers or any other GPS receiver capable of providing the remote device's real-time location.

In an embodiment, user interface 106 further includes input/output device(s) 108. The input/output device(s) may be used to facilitate interactions between a user and the remote device. For example, input/output device(s) include monitors, displays, keyboards, pointing devices, joysticks, buttons, touchscreens, graphical user interface buttons (GUI), etc., that communicate with a processor through user interface 130. In an embodiment, a user may use a keyboard or touchscreen to enter, or alternatively confirm, demographic and/or geographic information describing a specific person or global location.

In an embodiment, computing system 114 further includes memory 128. Memory 128 is implemented as a main or primary memory, such as random access memory (RAM). Memory 128 may include one or more levels of cache. The memory may have stored therein control logic, such as computer software, and/or data. In additional embodiments, memory may also include one or more secondary storage devices or memory such as a hard disk drive and/or a removable storage device or drive. The removable storage drive may include a floppy disk drive, a magnetic tape drive, a compact disk drive, and/or any other storage device/drive.

In an embodiment, computing system 114 further includes at least one processor 116. As depicted in FIG. 1, processor 116 further includes validation module 118, location module 120, global addressing module 122, and/or any other module necessary to perform the functionality described herein. In additional embodiments, processor 116 includes only a single module or any modules contemplated herein. Each module may be implemented as logic embodied in software, firmware, hardware, and/or operating system implementations in order to perform or carry-out a desired function. Further, as used herein, a module may also be implemented as a collection of software instructions. One or more software instructions in the modules may be embedded in firmware, such as in an erasable programmable read only memory (EPROM). The modules described herein may also be stored in any type of non-transitory computer-readable medium or other storage device.

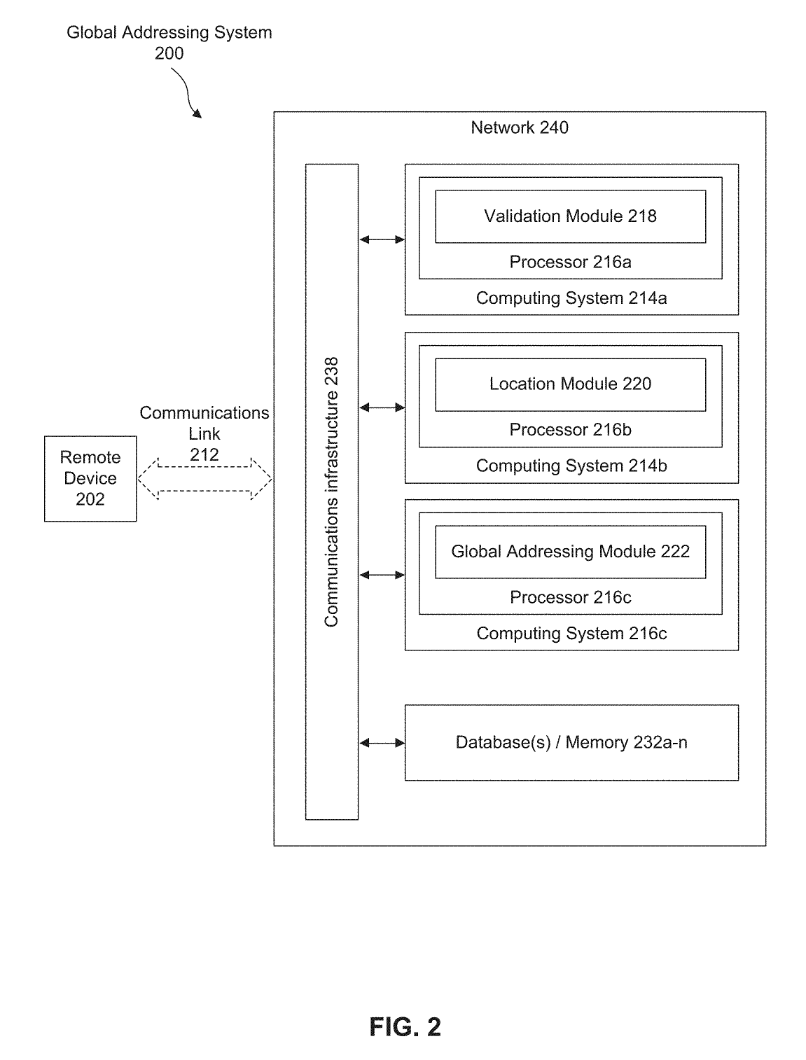

In an embodiment, the modules are incorporated using a single computing system and processor. In other embodiments, the modules are incorporated using more than one computing system and/or processor. Referring now to FIG. 2, shown is a non-limiting functional block diagram of global addressing system 200, useful for implementing various embodiments of the present disclosure. As shown, a remote device 202 (such as remote device 102) is in electronic communication with network 240 through communications link 212. Network 240 may be comprised of computer systems 214a-c, each having at least one processor 216a-c. The processors may send and receive data to/from other processors within the network and/or remote device 202 through communications infrastructure 238. For example, in an embodiment, validation module 218, located within computing system 214a, communicates with remote device 202 by transmitting data through communications infrastructure 238 and communications link 212. In another non-limiting example, location module 220 located within computing system 214b, may send and receive data with global address module 222 through communications infrastructure 238.

A network (such as network 240 of FIG. 2) may be implemented as a wide area network (WAN), a local area network (LAN), a metropolitan area network (MAN), or any other network capable of performing the functionality described herein. As such, a communications infrastructure (such as communications infrastructure 238 of FIG. 2) may be a wired and/or wireless connection. Further, the communications infrastructure may operate using a communications protocol such as: long term evolution (LTE), Wi-Fi, Bluetooth, radio-frequency, first generation (1G) wireless technology, second generation (2G) wireless technology, third generation (3G) wireless technology, fourth generation (4G) wireless technology, code-division multiple access (CDMA), frequency division multiple access (FDMA), generic access network (GAN), global system for mobile (GSM), or any other network protocol capable of sending and receiving data between nodes within a network and/or a remote device. Accordingly, network 240 may interact with remote device 202 over communications link 212 using any of the aforementioned protocols.

Various example, non-limiting embodiments, of contemplated software, firmware, hardware, and/or operating system modules shall now be discussed.

A validation module (such as validation module 118 of FIG. 1 or validation module 218 of FIG. 2) may provide security functionality. The validation module may be used to confirm the identity of the user. For example, in an embodiment, the user may be required to create a username and password. In an embodiment, the user may be required to confirm his/her identity using a credit card, a duplication of a passport, or biometric data such as a thumb print, finger print, or a retina scan. In an additional embodiment, a user's social media presence may be used to confirm his/her identity. In additional embodiments, the validation module may also track the IP address, location of the user device, MAC address of the user device, network specifications including cell tower or internet service provider locations, timestamps, and any other data that may be used to confirm the location of the user.

Location module 120 and/or location module 220 may be implemented to determine and/or confirm geographic data describing a specific person or geographic location. For example, in an embodiment, the location module may generate and provide an interactive map to confirm a geographic location of received user input. The user may interact with the map to select a location on the map. In an embodiment, the user may enter a street address, a city, state, zip code, country, principality or any other geographical identifier and the location module will present the location to the user through a user interface. The user may then manipulate the map display by zooming in and out; by panning up, down, or to any side or angle; by rotating the map clockwise or counterclockwise; or any other means for manipulating a map. In an embodiment, the user may place a marker in the exact spot on a map. Upon receiving confirmation that the selected global position is correct, the location module sends the geographic data to the global address module.

In an exemplary embodiment, a user may enter “Erbil City, Kurdistan Region, Iraq.” Upon receiving this inquiry, the location module produces a satellite image of the city and its surrounding region as retrieved from, for example, an image database (not shown). The user may then zoom in and pan the image to a desired location, such as a pasture behind his or her own residence using known graphical processing interfaces or interactive mapping technology. Upon placing a marker on the map, the location module will prompt the user to confirm the location. Upon confirming the location, the location module sends the geographic data of the selected location to the global address module.

In an embodiment, the location module may also generate recommended driving, walking, or cycling instructions/directions. The directions may originate from a specific business location in the region, a local airport, bus depot, or any other common hub for public transportation. In such an embodiment, the user may be prompted to confirm the instructions/directions. The user may also be prompted to define a more efficient travel route. As an example of such an embodiment, if the user entered the GPS coordinates “47° 02′09.4″N 9° 00′18.5″E”, the location module would detect a location near Glarus, Switzerland. Upon confirming the location, as described above, the location module would suggest traveling instructions from a Swiss Post Office, the Glarus train station, the Zurich International Airport, the Zurich HauptBahnhof, or any other transportation hub. Such locations may be determined, for example, from a database listing of such hubs identified by coordinates, using an algorithm to determine distances between hubs in the database and the GPS coordinates entered and then select the hubs having the smallest distance value. The user would then either select a suggested travel route or the user may be prompted to draw a more efficient route.

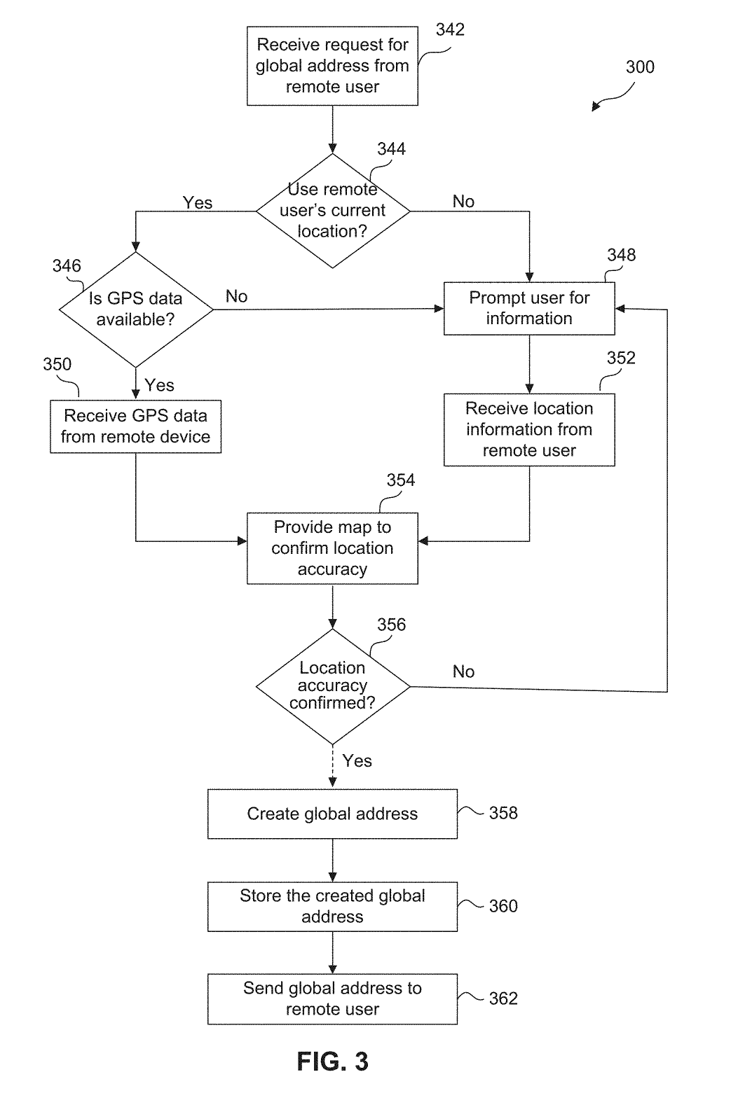

Global address module 122 and/or global address module 222 is used to generate a specific global address or global address code based on demographic and/or geographic data describing a specific person or geographic location. In an embodiment, the global address module receives user input, processes the received embodiment, and generates the global address code. In an embodiment, the received user input describes a specific global location. The user input describing a specific location may include at least one of: a nationally recognized street address, residential or commercial property, business name, resident name, longitude, latitude, and altitude. In an embodiment, the global address module may receive specific location data from the location module. In an additional embodiment, the specific location data may be received from the user directly. The generated global address code will be discussed in greater detail below, with reference to FIG. 3.

Database/Memory 132a-n and/or Database/Memory 232a-n may be implemented within network 240 to provide additional storage space.

Various example, non-limiting embodiments, of contemplated global address creation methods shall now be discussed.

FIG. 3 illustrates method 300, a method for creating a global address using the global addressing systems illustrated in FIGS. 2 and 3, as described above. At step 342, the system receives a request for a global address from a remote user.

At step 344, the system determines whether to use the remote user's current location or a different location. This determination may be performed by prompting the remote user to select a “use current location” option and/or based on the information received at step 342. For example, the information received at step 342 may indicate that the user's current location is to be used. Such information may include a checkbox, graphical user interface, web-form, or saved preferences based on a user account indicating the remote user's selection.

At step 346, the system determines whether GPS data is available. If the GPS data is available, the system advances to step 350, where it is determined that the remote device is associated with the remote user. Step 350 will be discussed in greater detail below. If the GPS data is not available, the system may prompt the remote user to turn on the device's GPS system (not shown) or the system may automatically advance to step 348.

At step 348, the system prompts the user for demographic and/or geographic information to be used in creating a global address and/or a user account. Demographic data may include: first name, last name, age, gender, household information, etc. Geographic information may include: current street address (when possible), zip code (when possible), global latitude, global longitude, elevation, or any other information that may be used to identify a specific global location. In an embodiment, step 348 may further include providing an interactive map where the user may place a map indicator over the specific global location. In an embodiment, the interactive map will assist the system in determining the latitude, longitude, and altitude of the indicated location.

At step 352, the system receives the information from the remote user. In an embodiment, step 352 may further include checking the received data for errors. For example, if the received information provides a global location that is on a mountain top, in the ocean, or another uninhabitable place, the system may return to step 348.

Returning now to step 350, the received data may include latitude, longitude, altitude, or any other data point that may indicate the global position of the device. In an embodiment, the system may use a cellular network, wifi network, or any other type of data network to triangulate the location of the remote device in order to determine the global position of the remote user and the remote device.

At step 354, the system provides a map for the user indicating the received geographic location. For example, if the user entered the latitude: 77° 03′50.4″W and longitude: 38° 48′04.2″N, the map will display a map indicator at the United States Patent and Trademark Office in Alexandria, Va., USA. If the user entered the latitude: 43° 57′23.6″E and longitude: 36° 14′00.9″N, the may will display a map indicator at the Erbil International Airport in Erbil, Kurdistan, Iraq.

At step 356, the system will prompt the user to confirm the accuracy of the map indicator placed on the map provided at step 354. If the indicator is not placed correctly, the system will return to step 348. If the indicator accurately depicts the specific location, the system advances to step 358.

At step 358, the system creates the global address based on the received latitude, longitude, and altitude. The global address may be created in the form of a barcode, a matrix barcode, a quick response code (“QR code”), or a machine-readable optical label. In an embodiment, the location code may define a shape, based on a feature of the remote location. For example, in an embodiment where the system creates a QR code for a location within Kenya, the QR code may define a shape of the letters “KE.” Or, where the system creates a QR code for a location within Iraq, the QR code may define a shape of the letters “IQ.” Or in an additional embodiment, where the system creates a QR code for a location within the Netherlands, the QR code may define the shape of the geographic boundaries of the country.

At step 360, the system stores the created global address in at least one database and/or memory device.

At step 362, the system provides the global address to the remote user. In an embodiment, the system provides the global address in a printable format, so the remote user can print the global address onto a printable medium, including: paper, a sticker, a box, or any other medium that may be used to ship a letter, parcel, or package, or a printable medium that may alternatively be affixed to a letter, parcel, or package. In an additional embodiment, the global address may be provided to the user in a sharable electronic format such as a picture, image, pdf, or other medium commonly used to share images.

Various example, non-limiting embodiments of delivery systems that use the contemplated global address shall now be discussed.

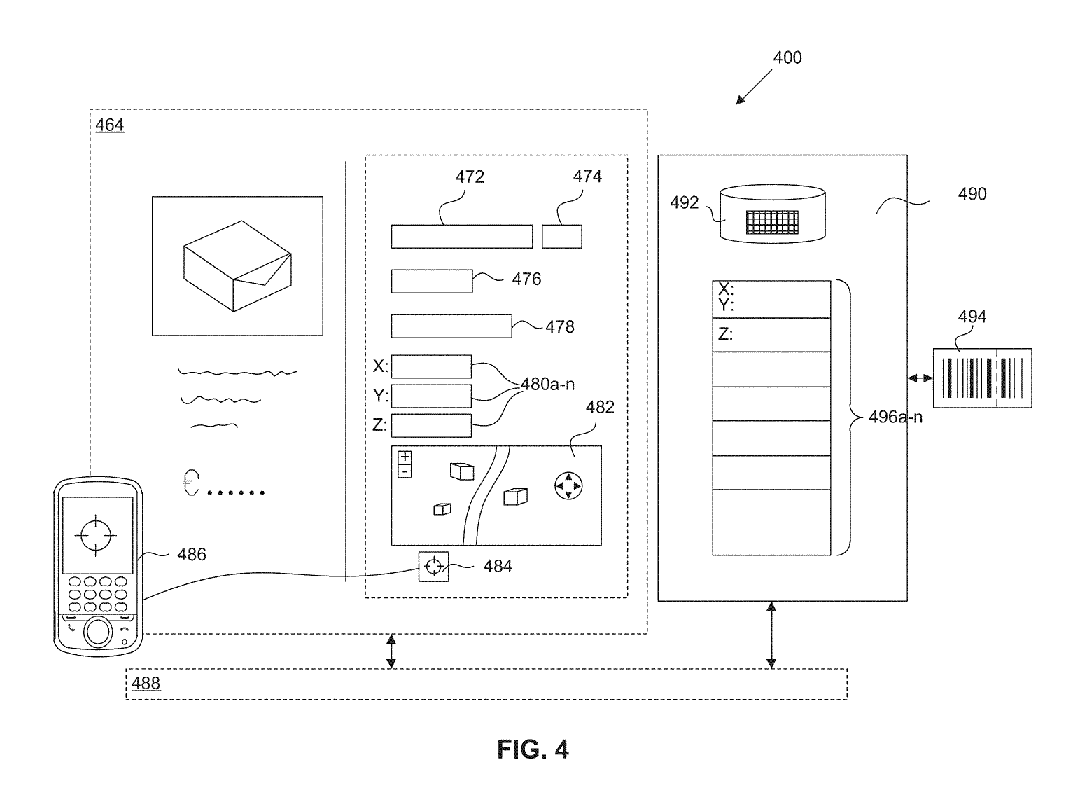

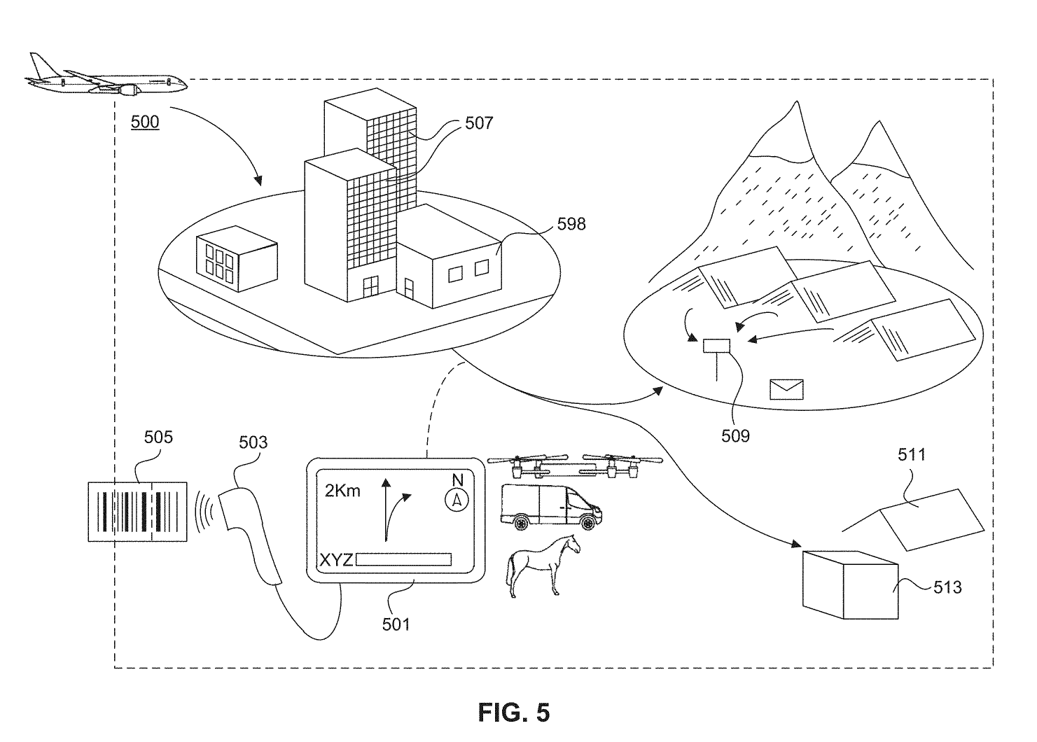

FIGS. 4 and 5 show delivery systems 400 and 500, respectfully, for delivery of services and goods using a global address according to embodiments. Delivery system 400 comprises an ordering section 464 for ordering of goods and services, and a localization section 490 for choosing or determining a desired delivery location.

The ordering section 464 is a part of a website, an application, or a mobile application (an ‘app’) which is offered by a supplier of services and/or goods. For example, the website or app may be offered by a shipping company and/or a parcel service. The ordering section 464 is provided with an interface which is reachable by the intended recipient of the services and goods, in most cases a consumer. As an alternative, the interface may also form part of an internal ordering system of a supplier of the services or goods. The interface comprises representation and input for obtaining and inputting data about the desired service or the desired goods. Furthermore, the ordering section 464 is electronically coupled to the localization system 490, over network link 488, for inputting data, such as a street name 472, a postal code 476 and/or a house number 474, if available. Additionally, the option can be provided to designate a drop-box 478. The ordering section 464 is further provided with input fields 480a-n for the input of coordinates, preferably GPS coordinates, an interactive map 482 for manually marking a delivery location, or a localization module 484 for retrieving the current location of the recipient. The current location of the recipient can be retrieved, for example, on the basis of the current location of a mobile device 486, such as a telephone, tablet or laptop. The localization module 484, for example, comprises instructions for communicating with the software of the mobile device 486 to obtain data about the current location of the mobile device. The mobile device can, for example, establish the current location from triangulation with nearby cell towers or on the basis of a GPS module in mobile device 486. Applications using data about the current location of a mobile device are categorized as ‘Location Based Services’ (LBS).

The input location data or location data that has been otherwise generated are transmitted, over network link 488, to the localization system 490 during or after finalizing the order. The localization system 490 is provided with processing and/or conversion software 492 for processing, interpreting and/or converting the location data about the delivery location into a predetermined data format and a storage medium for storing the location data in a database structure. In an embodiment, the predetermined data format is constructed from a group of components comprising: XY coordinates (496a-n) which are indicative of the longitude and latitude of the desired delivery location, a Z coordinate (496a-n) that is indicative for the height, preferably above sea level, at which the delivery location is located and furthermore, if available, an indication of a name, an indication of a street, an indication of a house number, an indication of a place, postal code, province and/or country, and optionally special remarks about the delivery location. The location data is digitally coupled to or stored with the data about the order. If so desired, the location data can be converted into a compact location code 494 and visualized on a screen or offered for printing on a label which can be applied to the product that is to be delivered.

FIG. 5 illustrates delivery system 500. Indeed, the logistics chain according to FIG. 5 is relatively simple up to a local warehouse 598 that is located in an area with recognized, conventional addressing. The delivery up to this point can take place with the delivery system according to the invention as well as conventionally, based on street name, postal code and house number. From the warehouse 598 onwards, delivery is executed based on the stored location data. The delivery system comprises a navigation system 501 with a scanner 503 for scanning a location code 505, or an interface for inputting digitally provided or printed location data (not shown). The navigation system 500 in this example is a GPS based navigation system.

The navigation system 500 can be provided using any means of transportation, for example and without limitation: a truck, a car, a bicycle, a quad-copter, a drone, a pack animal, or any other method for delivering a package or parcel. The navigation system 500 is not limited to navigation via registered roads, but can also provide assistance when navigating to coordinates, such as the XYZ coordinates. When delivering at heights (the Z coordinate), for example in a multi-level building 507, delivery to a designated location in the lobby or on the roof 511 is also possible. Use can also be made of a drop-box 509, 513.

Communication of the location data between the ordering section, the localization system and the delivery system is preferably executed via secure connections. Furthermore, the database structure is protected against intrusions by unauthorized third parties. This ensures the privacy of the involved parties. If so desired, the localization system could, however, allow for selective data exchange. For example, in return for a fee, data may be provided to third parties for the purpose of marketing goals or governmental goals.

In an alternative embodiment, the processing and/or conversion software of the localization system is arranged for checking the input or obtained location data based on the predetermined preconditions, and is further arranged for providing a notification of rejection to the ordering section 464 in the case that the location data does not meet the preconditions. A precondition can, for example, be a limited geographical delivery area, such as based on series or ranges of allowed and excluded XY coordinates or excluded places, postal codes, provinces or country indications. For example, if the XY coordinates indicate an area within a warzone, the system may reject such an address designation.

In a more general application of the invention, the processing and/or conversion software is arranged for assigning the input or obtained location to a person, a company, or a delivery location for a limited period of time. The period of time is, for example, a given number of days, weeks or months. During this period, the person or company can use the assigned location for purposes such as the aforementioned delivery of goods and/or services, or other purposes. After expiration of the limited duration, the assigned location is unassigned or deleted. In an embodiment, the system may maintain records of the username, password, and/or confirmed identity of the user associated with the location. As an additional security measure and to ensure lawful conduct/use of the global address systems described herein, global address and identity information may be shared with local law enforcement agencies.

In a further embodiment of the invention, the processing and/or conversion software of the localization system is arranged for converting the input or obtained location data to a easily readable format, for example a code 505 with text or visual elements. In particular, the processing and/or conversion software is arranged for at least partially converting the XY coordinates and optionally the Z coordinate to a code 505 from which the continent, the country, the province and/or place associated with said coordinates can be easily read. The code 505 then comprises at least a first component which enables delivery with the use of a GPS based navigation system, for example with a part of or the entire XY coordinates, and a second component which indicates continent, country, province and/or place. In this manner, a global, universal postal code can be obtained. The second component is derived by the processing and/or conversion software from the given XY coordinates by comparing these coordinates with known series or ranges of coordinates for certain continents, countries, provinces and/or places.

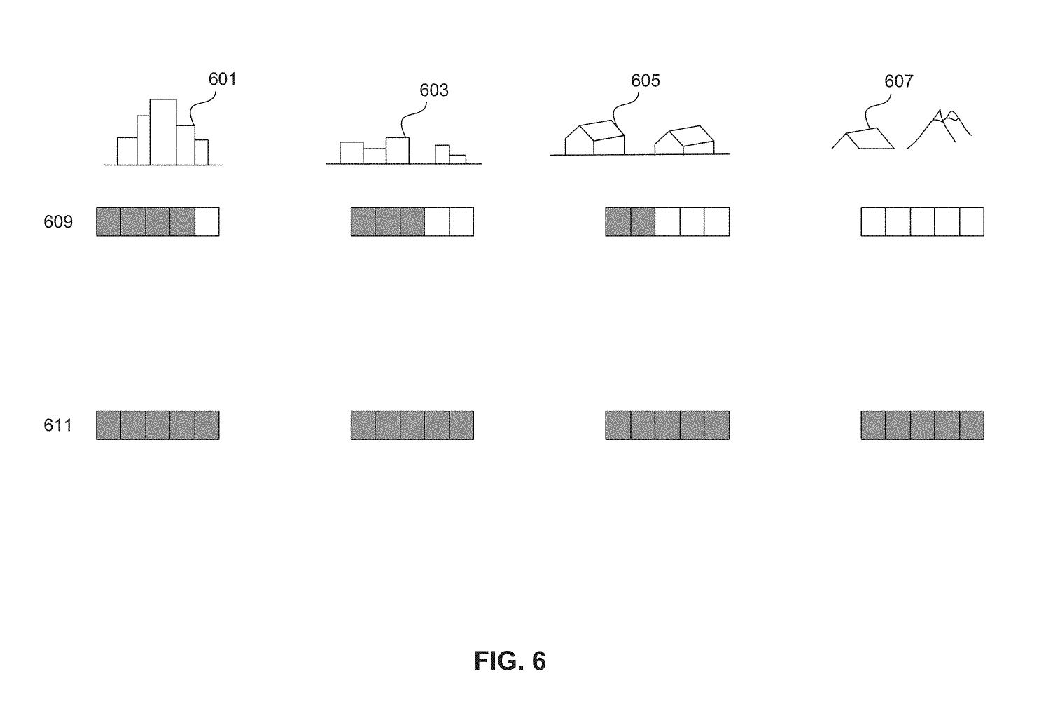

As schematically shown in FIG. 6, the coverage area of the localization system and the delivery system is enlarged by using the XY coordinates according to the invention, such that locations can be unambiguously determined in cities 601, as well as towns 603, rural areas 605 and nomad or adventurous locations 607. In particular, the comparison is made between a first series of coverages 609 for the aforementioned areas when using conventional addressing based on street names and house numbers, and a series of coverages 611 when using the delivery system and the localization system according to the invention.

It is to be understood that the above description is included to illustrate the operation of the preferred embodiments and is not meant to limit the scope of the invention. From the above discussion, many variations will be apparent to one skilled in the art that would yet be encompassed by the spirit and scope of the present invention.

1. A system for creating a global address, the system comprising:
a memory;
at least one processor coupled to the memory; and
an encrypted communications link configured to transmit electronic data between a remote device associated with a specific remote user and the at least one processor using a data encryption protocol,
the at least one processor configured to:
receive, from the remote device, account information describing the remote user;
determine global location data describing a delivery location, based on a selection received from the remote device using an interactive map,
wherein the delivery location is at least one of a nomad location and an adventure location, wherein the delivery location does not have a government recognized address and is not accessible using public roadways or buildings;
validate the received account information and the received global location data;
determine navigational data, wherein the navigational data comprises a plurality of directions for physically accessing the delivery location from a transportation hub, wherein the transportation hub is an airport, bus depot, bus stop, or train station;
create a location code, comprising the account information, the global location data, and the navigational data,
wherein the location code is a matrix barcode defined by a sequence of shapes that represent at least one direction of the plurality of directions for physically accessing the delivery location from the transportation hub;
store the location code and the navigational data in memory; and
send the location code to the remote device.

2. A method for creating a global address, the method comprising:
receiving, from a remote user, account information describing the remote user and global location data describing a delivery location, wherein the delivery location is at least one of a nomad location and an adventure location, wherein the delivery location does not have a government recognized address and is not accessible using public roadways or buildings;
validating the received account information and the received global location data;
determining navigational data, wherein the navigational data comprises a plurality of directions for physically accessing the delivery location from a transportation hub, wherein the transportation hub is an airport, bus depot, bus stop, or train station;
create a location code comprising the account information, the global location data, and the navigational data,
wherein the location code is at least one matrix barcode defined by a sequence of shapes that represent at least one direction of the plurality of directions for physically accessing the delivery location from the transportation hub;
storing the location code and the navigational data on a network database; and
sending the location code to the remote user,
wherein at least one of the receiving, validating, determining, creating, storing, and sending are performed by one or more processors, and
wherein at least one sending or receiving step is performed using a data encryption protocol.

3. The method of claim 2, wherein receiving the account information further comprises receiving a username and password from the remote user.

4. The method of claim 2, wherein receiving the global location data further comprises:
providing an interactive map to the remote user;
receiving a selection from the remote user, wherein the selection describes a location on the interactive map; and
determining the latitude, longitude, and altitude of the selection.

5. The method of claim 2, wherein receiving the global location data further comprises:
providing a user interface configured to receive input;
receiving, at the user interface, input from the remote user describing a global location; and
determining the latitude, longitude, and altitude of the global location described by the received input.

6. The method of claim 2, wherein receiving the global location data further comprises:
accessing a plurality of mobile towers;
triangulating a global location of the remote user using the mobile towers; and
determining the latitude, longitude, and altitude of the triangulated global location.

7. The method of claim 2, wherein validating the received account information further comprises authenticating a username and a password associated with the remote user.

8. The method of claim 2, further comprising printing the location code on a box, a package, a parcel, an envelope, paper, tape, paper or any combination thereof.

9. The method of claim 8, further comprising sending, to the remote computer, packaging information describing at least one of a box, a package, a parcel, or an envelope that is to be sent.

10. A method for requesting a global address, the method comprising:
sending, to a remote computer, account information describing a local user and global location data describing at least the longitude, latitude, and altitude of a specific delivery location, wherein the delivery location is at least one of a nomad location and an adventure location, wherein the delivery location does not have a government recognized address and is not accessible using public roadways or buildings;
receiving, from the remote computer, navigational data, wherein the navigational data comprises a plurality of directions for physically accessing the specific delivery location from a transportation hub, wherein the transportation hub is an airport, bus depot, bus stop, or train station;
receiving, from the remote computer, a location code comprising the account information, the specific delivery location, and the navigational data,
wherein the location code is at least one matrix barcode defined by a sequence of shapes that represent at least one direction of the plurality of directions for physically accessing the delivery location from the transportation hub;
printing the received location code onto a printable medium, thereby producing a physical label; and
providing the physical label for delivery to the specific delivery location,
wherein at least one of the sending, receiving, printing and providing are performed by one or more processors,
wherein at least one sending or receiving step is performed using a data encryption protocol, and
wherein sending the delivery location data further comprises selecting a specific location on an interactive topographical map.

11. The method of claim 10, wherein sending the account information further comprises submitting a username, password, and encryption key to the remote computer.

12. The method of claim 10, further comprising receiving, from the remote computer, a selection indicating a transportation hub near the delivery location.

13. The method of claim 10, wherein the location code further comprises-at least one of a barcode a quick response code, or a machine-readable optical label.

14. The method of claim 10, wherein the physical label is printed on a box, a package, a parcel, an envelope, paper, tape, paper or any combination thereof.

15. The method of claim 10, further comprising sending, to the remote computer, packaging information describing at least one of a box, a package, a parcel, or an envelope that is to be sent.

16. The method of claim 15, wherein the packaging information comprises a height, width, length, and weight of the box, package, parcel, or envelope.

17. The method of claim 10, further comprising receiving, from the remote computer, a preferred delivery method selected from the group consisting of a drone, a quadcopter, a bicycle, and a pack animal.

18. A tangible computer-readable device having instructions stored thereon that, when executed by at least one computing device, causes the at least one computing device to perform operations comprising:
sending, to a remote processor, account information describing a local user and global location data describing a specific delivery location, wherein the delivery location is at least one of a nomad location and an adventure location, wherein the delivery location does not have a government recognized address and is not accessible using public roadways or buildings;
receiving, from the remote computer, navigational data, wherein the navigational data comprises a plurality of directions for physically accessing the specific delivery location from a transportation hub, wherein the transportation hub is an airport, bus depot, bus stop, or train station;
prompting the local user to confirm the accuracy of the navigational data;
receiving, from the remote computer, a location code comprising the account information, the specific delivery location, and the navigational data; and
converting the received location code into a format compatible for printing,
wherein the converted location code is at least one matrix barcode defined by a sequence of shapes that represent at least one direction of the plurality of directions for physically accessing the delivery location from the transportation hub and
wherein at least one sending or receiving step is performed using a data encryption protocol.

19. The computer-readable device of claim 18, wherein the location code further comprises at least one of a barcode, a quick response code, or a machine-readable optical label.

20. The computer-readable device of claim 18, wherein receiving the global location data further comprises:
providing a user interface configured to receive input;
receiving, at the user interface, input from a remote user describing the delivery location; and
determining the latitude, longitude, and altitude of the delivery location described by the received input.

21. The computer-readable device of claim 18, wherein receiving the global location data further comprises:
providing an interactive map to a remote user;
receiving a selection from the remote user, wherein the selection identifies a location on the interactive map; and
determining the latitude, longitude, and altitude of the selection.
